(19) United States
(12) Patent Application Publication
(10) Pub. No.: US 2010/0126056 A1
(43) Pub. Date: May 27, 2010

(54) Field dress stabillizer

(76) Inventors: Scott R. Nice, Logan, OH (US); Charles B. Weed, New Straitsville, OH (US)

Correspondence Address: Charles B. Weed, 6340 Monday Creek Twp. Rd. 131, New Straitsville, OH, 43766, US

(21) Appl. No.: 12/313,876

(22) Filed: Nov. 24, 2008

(51) Int. Cl. A01M 31/00; A22B 5/00

(52) U.S. Cl. 43/1; 452/198

(57) ABSTRACT

An apparatus and method that will enable a hunter to safely and easily field dress a dead animal. The apparatus includes a stake and two straps (one longer than the other) that are connected to each other, to the stake and to the dead animal's legs. The single stake can be inserted into the ground and each set of straps is adapted to be attached to stake and to one or more of the dead animal's legs. The hunter has the ability to use one, two, three or four sets of straps to restrain/control/stabilize as many of the dead animal's legs as that hunter desires to restrain/control/stabilize. The hunter also has the opportunity to use no stake and still safely, easily and successfully field dress their dead animal.

### CROSS REFERENCE TO RELATED APPLICATIONS

None

### FEDERALLY SPONSORED RESEARCH

Not Applicable

### SEQUENCE LISTING OR PROGRAM

Not Applicable

### BACKGROUND OF THE INVENTION'S FIELD

This present invention application relates generally to hunting. It is an apparatus and method to use that apparatus to assist hunters to safely, easily and successfully field dress the dead animal that they have killed.

Many state's hunting laws require hunters to remove the dead animals internal organs while still in the field. This process is referred to as “field dressing” the animal. Field dressing large dead animals (often referred to in the literature as “game”), such as bear, caribou, cougars, deer, elk, goats, lions, moose, rams or sheep can be a dangerous, difficult and awkward task for a hunter to perform when hunting alone without an appropriate apparatus such as proposed in the present invention. In particular, with large dead animals it is difficult to hold both of the dead animal's rear legs apart while using an extremely sharp knife or other eviscerating tool. Some hunters solve this problem by hunting with companions who then can help them field dress their dead animal. However, hunters who are hunting alone (often, always or on that particular hunt) do not have the option of a companion's help. Even hunters who have companions to assist them to restrain/control/stabilize their dead animal create a burden on their companion hunter. The companion hunter may (a) have to descend from their tree or stand and (b) possibly miss an opportunity to bring home their own prized animal because they were busy giving assistance to their companion. Therefore, there exists a need for an apparatus and method that will allow hunters to safely, easily and successfully field dress large dead animals without the aid of another person. In particular, there is a need for an apparatus and method for restraining/controlling/stabilizing the dead animal's rear legs to facilitate the hunter's safe, easy and successful use of their chosen evisceration tools.

We have discovered but one apparatus/method of prior art in literature and patents. The other apparatus/method uses a fixed length “strap” (in the generic sense of that word) with a fixed length loop on one end of the “strap” together with an anchor for both of the dead animal's rear legs. It the other apparatus' anchor could not be used to field dress the hunter's dead animal because the terrain is too rocky or hard to insert either or both anchors, an anchor broke while the hunter was inserting that anchor into the ground or the hunter forgot to pack one or more of the anchors or lost one or more of the anchors from his hunting pack during the trek to where they waited for a suitable animal and killed it. It is also possible that the length of the “strap” or the fixed loop needs to be larger or smaller for the hunter's dead animal. Therefore, the other apparatus/method would not solve that hunter's dilemma—how could that hunter safely, easily and successfully field dress that dead animal.

### SUMMARY

The present invention provides an apparatus and method to assist hunters to field dress dead animals. All of the embodiments of the present invention specifically provide mechanical apparatuses for restraining/controlling/stabilizing both the front and rear legs while they field dress their dead animal. The present invention's apparatuses/methods include but one stake and one or more straps for the dead animal's legs. The stake is shaped to be easily inserted into the ground.

One embodiment of the straps is a set of two straps. The longer strap has a means on one end through which the stake can be inserted through the long strap before the stake is inserted into the ground. In this embodiment there is also a shorter strap which would have an infinitely adjustable loop for attaching the short strap to one of the dead animal's legs. The two straps have a connector to facilitate the connection of the two straps. Another embodiment uses just one longer strap (rather than a set of straps) with a means on one end of the strap to connect the stake and the infinitely adjustable loop on the strap's other end,

The present invention also contemplates a method for field dressing a dead animal. The method includes the following steps:
1. After the first apparatus—the stake—is inserted through opening on one end of the third apparatus—the longer strap—the stake should be inserted into the ground,
2. The longer strap should then be pulled out to the side of where the dead animal will be placed (or both sides of the dead animal if multiple longer straps are to be used to restrain/control/stabilize multiple legs of the dead animal).
3. The dead animal should be placed over the stake and the opening on one end of the longer strap.
4. An infinitely adjustable loop on one end of the shorter strap can be placed over one (or more) of the dead animal's rear legs and connected to the one/or more longer strap(s) which has/have been anchored into the ground using the stake. Thereafter, the rear legs of that dead animal can be restrained/controlled/stabilized by adjusting the tension on the combined longer and shorter strap(s).
5. The tension can be easily adjusted by pulling on the angled, adjustable end of the longer strap(s) which has/have been pulled through the connector of the two straps.
6. The tension should be adjusted to the hunter's satisfaction before the hunter field dresses their dead animal.
7. The dead animal will be restrained/controlled/stabilized because of one stake, the animal's own dead weight over that stake and the hunter's chosen tension on the straps.
8. The hunter could use just one set of straps (longer and shorter) to restrain/control/stabilize just one leg or as many as four sets of straps to control all of the dead animal's legs.
9. The decision about how many sets of straps and/or whether or not to use a stake for field dressing any dead animal can be made by the hunter for all hunts or when the hunter is in the field with each dead animal.

Because of experience, the inventor's realize that the hunter may find that the terrain where the dead animal has been killed may not allow the use of the present invention's first apparatus—the stake. In that event, hunters can still restrain/control/stabilize their dead animal using one of the other embodiments of the present invention by:
1. Creating an infinitely adjustable loop on one end of the longer strap,
2. Repeating that step with a second long strap if both rear legs are to be restrained/controlled/stabilized,
3. Placing the longer strap(s) on the ground so that the dead animal could be placed over the longer strap(s) with the created, infinitely adjustable loop on one side of where the dead animal will be placed and the adjustable end of the longer strap on the other side of the dead animal,
4. Placing, at the hunter's option, another longer strap on the ground so that the dead animal could be placed over two longer straps with one of the created adjustable loops on each side of where the dead animal will be placed and the adjustable end of the long strap on the other side of the dead animal if both rear legs are to be restrained, controlled, stabilized,
5. Placing the dead animal over the longer strap(s), and
6. Following the first method's method to put the created, infinitely adjustable loop over each of the dead animal's front legs and attach the other end of that longer strap to the shorter strap's connector which has been connected to the opposite rear leg of the dead animal,
7. Tightening the tension for each of the dead animal's legs that are to be restrained/controlled/stabilized.

Once the animal has been restrained/controlled/stabilized in the above manner, the dead animal can be easily and, more importantly, safely field dressed even without the use of any stake/anchor.

The present invention provides significant advantages over previously described products and methods. The apparatus of the present invention is not only light and portable, it allows a hunter to safely, easily and successfully field dress their dead animal while alone, no matter how large the dead animal may be. No longer is it necessary to seek and ask for the aid of any other hunters if the hunter has others hunting with them. The present invention has multiple apparatuses that can be used in an almost endless variety of ways so that no matter how large the dead animal or how difficult the terrain, the hunter can safely, easily and successfully field dress their dead animal. No longer must the hunter need to use some of his body parts (hands, arms and/or legs) to restrain/control/stabilize the dead animal and keep the dead animal's body and legs from twisting or otherwise moving around while using an extremely sharp eviscerating tool. Instead, the hunter can concentrate solely on process of removing the animal's inner organs.

Various other features, objects, and advantages of the invention will be made apparent to those skilled in the art from the accompanying drawings and detailed description thereof.

### DRAWINGS—FIGURES

None of the drawings are drawn to any consistent scale. However, the relationship of each apparatus to each of the other apparatuses is clearly shown. In addition, at least one embodiment of each of the parts of the apparatuses can be seen and explained by the 14 drawings. Certain of the portions of each figure have been chosen to illustrate the type of attachment to the strap. In each instance, the illustrated attachment was selected from the type of attachments in the group of attachments that are claimed for this invention. In two instances an alternate attachment is also illustrated in a sub figure.

FIG. 1 shows a view of the first apparatus—the stake—with the stake's custom handle at the top and the stake's insertion point (on the other end of the stake).

FIG. 2 shows the view that would occur if you turned the first apparatus—the stake—90° (in either direction) from the view in FIG. 1. (Note that the handle top of the stake is not visible in this view).

FIG. 3a shows a view looking down on the second apparatus—the shorter strap—with the shorter strap's connector laying flat. In this view, the end of the shorter strap opposite of the connector shows a sewn fixed length loop.

FIG. 3b shows an alternate view looking down on the second apparatus—the shorter strap—with the shorter strap's connector laying flat. In this view, the end of the shorter strap opposite of the connector shows a “D” ring instead of FIG. 3a's sewn fixed length loop.

FIG. 4a shows a view looking at a side view of the second apparatus shown in FIG. 3a—the shorter strap. In this view, the end of the shorter strap opposite of the connector shows the sewn fixed length loop.

FIG. 4b shows a view looking at a side view of the second apparatus shown in FIG. 3a—the shorter strap. In this view, the end of the shorter strap opposite of the connector shows a “D” ring instead of FIG. 4a's sewn fixed length loop.

FIG. 5 shows a view of the shorter strap shown in FIG. 4 with an infinitely adjustable loop on the end of the shorter strap that is opposite from the connector. The infinitely adjustable loop is created by inserting the connector through the sewn fixed loop on the end of the short strap.

FIG. 6a shows a view looking down on the third apparatus—the longer strap—with a “D” ring laying flat.

FIG. 6b shows a view looking down on the third apparatus—the longer strap—with a sewn fixed length loop instead of the “D” shown in FIG. 6a.

FIG. 7 shows a view of the shorter strap shown in FIGS. 4 & 5 with the adjustable end of the longer strap (FIG. 6) inserted through the buckle.

FIG. 8 shows a method to use a longer strap with the stake to create an anchor to restrain/control/stabilize the dead animal.

FIG. 9 shows a method to use two (or more) longer straps with the stake to create an anchor to restrain/control/stabilize the dead animal.

FIG. 10 shows an alternate method to use a long strap with an infinitely adjustable loop which is created by inserting the adjustable end of the longer strap though the longer strap's own “D” ring. In this method a stake is not necessary would not be used.

FIG. 11 shows an alternate method to anchor the dead animal which combines two (or more) of the longer straps to create an alternate method to restrain/control/stabilize the dead animal. In this method the stake is also not necessary and the stake is not used.

### DRAWINGS—REFERENCE NUMERALS

| | | | |
|---|---|---|---|
| 20 | Stake | 22 | Custom Handle of Stake |
| 24 | Shorter Strap | 26 | Connector on Shorter Strap |
| 28 | Indication of sewing strap | 30 | Sewn Fixed Length Loop |
| | parts | | on Shorter Strap |
| 32 | Infinitely Adjustable Loop on | 34 | Longer Strap |
| | Shorter Strap | | |
| 36 | “D” Rings | 38 | Adjustable End of Longer Strap |
| 40 | Infinitely Adjustable Loop on | | |
| | Longer Strap | | |

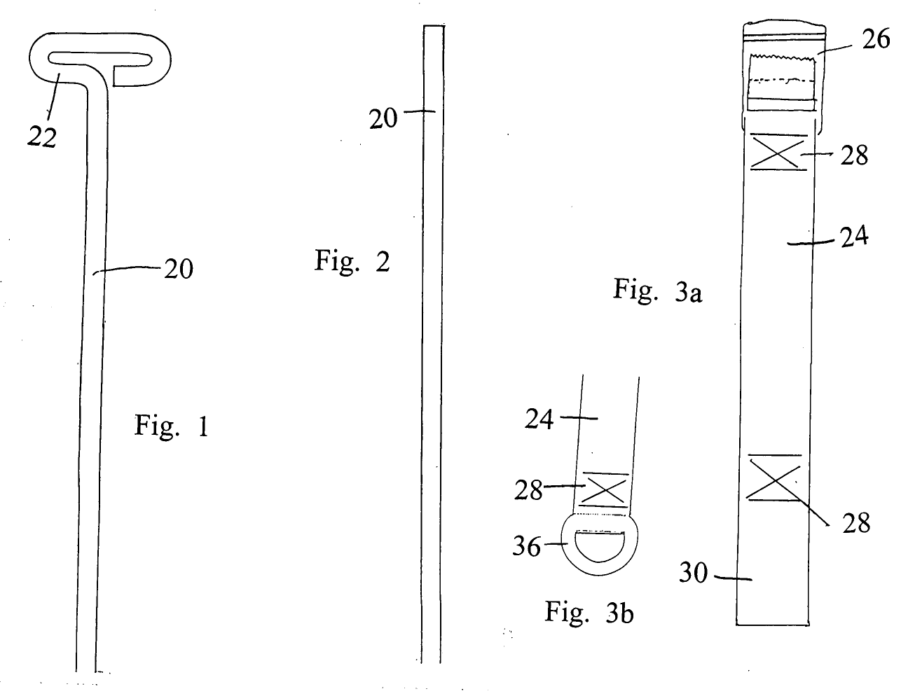

### DETAILED DESCRIPTION AND OPERATION—FIRST EMBODIMENT—FIGS. 1-9

The illustration in FIG. 1 shows the first apparatus—the stake (20)—with its custom handle (22). The stake (20) that is illustrated was designed to be pressed out of steel wire with a custom handle (22) which was made to fit the palm of the hand for the initial insertion of the stake (20) into the ground. The stake's (20) custom handle (22) could be inserted further into the ground, if necessary, by using the notch between the hunter's heel and the sole of their boot if the ground is too hard to insert the stake (20) all the way to the custom handle (22) using the hunter's hand alone. One finished size of the wire to makes the stake (20) is 0.21″ which gives substantial strength for long term use without making the stake (20) too difficult to insert into the ground. However, the hunter who uses such a stake should use caution whenever the hunter determines that they must use their foot to insert the currently illustrated and described stake (20) further into the ground because the stake's (20) diameter was chosen both to (a) ease the stake's (20) entry into the ground and (b) reduce the cost of this portion of the invention.

The custom handle (22) of the stake (20) could have been made of wood, plastic, iron pipe or other material instead of steel wire but we were required by the rules when seeking a patent to show and describe at least one method and material to be used to make the invention. This embodiment allows the stake to be made with a greater or lesser diameter wire or another material but there are durability and cost differences to be weighed in any adjustment of the stake's diameter or material that is used.

The illustration in FIG. 2 needs no other explanation. It provides little additional information except what the stake (20) looks like from a different angle.

The illustration in FIGS. 3a and 3b shows the second apparatus—the shorter (24) strap—looking down on the top of the strap (24) and its connector (26) with two different type of ends opposite the connector. The design which looks like an “|x|” (28) on the straps is where the strap has been folded over on itself and sewn together using that pattern to attach some object to the strap or to double over the strap and create a sewn fixed length loop (30). The shorter strap can be made of any number of materials as described in the claims. Other types of connectors could also be used to attach the shorter (24) strap to the third apparatus and thereby, ultimately, to the stake (20). A choice of connector type (26) had to be made for the sake of the illustration and a cam buckle was actually shown which type of connector will easily allow the creation of the hunter's desired tension restraining/controlling/stabilizing the hunter's dead animal but that connector is not the only reasonable connector to be used for this apparatus. Instead of the sewn fixed length loop (30), the invention could use a “D” or “O” ring or a grommet. On the end of the shorter (24) strap that is opposite the connector (26), there is a sewn fixed length loop (30) illustrated in FIG. 3a and in FIG. 3b there is shown the alternate use of a “D” Ring (36). While fixed loops (30) such as shown in FIG. 3 could be used to go around the dead animal's leg, the size of dead animal's legs vary so greatly from species to species and even within a species that the inventors are of the opinion that an infinitely adjustable length loop (32) ) which (a) can be created by the hunter and (b) will be shown in FIG. 5) would be a much better loop be used to go around the dead animal's leg.

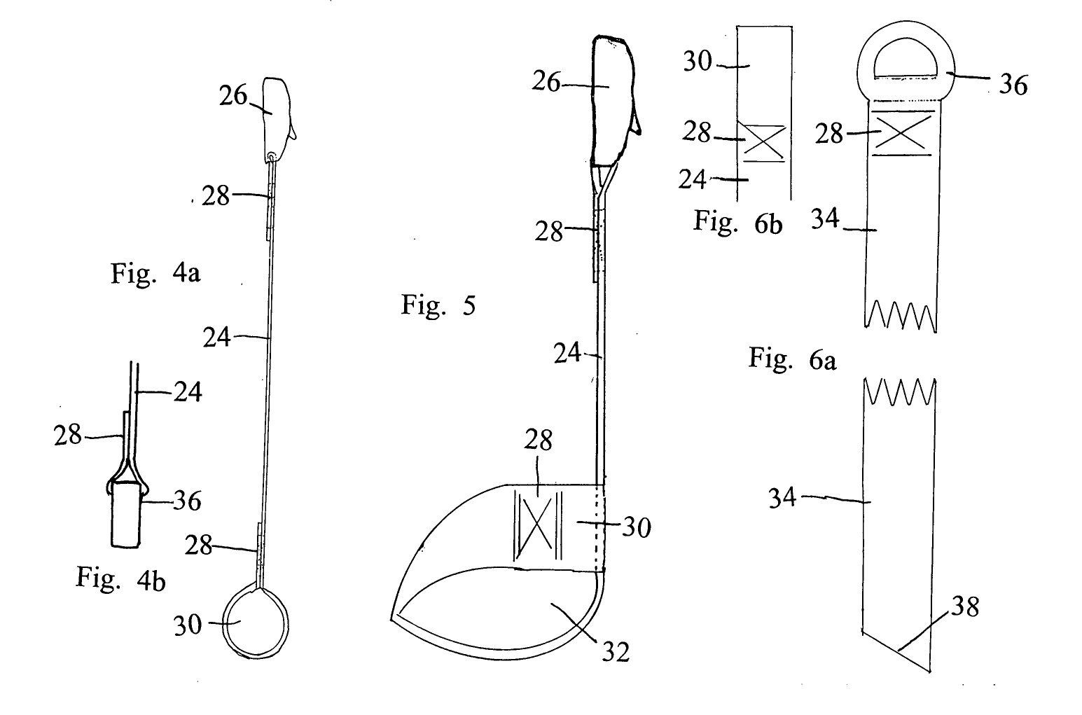

The illustration in FIGS. 4a and 4b shows the second apparatus—the shorter (24) strap—looking from the side of the shorter (24) strap and its connector (26). The view in FIG. 4a allows a better illustration of the sewn fixed length loop (30) which is shown on the end of the shorter (24) strap that is opposite the connector (26). If FIG. 4b instead of the sewn fixed length loop (30) illustrated in FIG. 4a, there is shown the alternate use of a “D” Ring (36).

The illustration in FIG. 5 shows the second apparatus—the shorter (24) strap—again looking from the side of the shorter (24) strap and its connector (26). The reason that this view has been included is that it allows the illustration of the better type of loop to control the animal's leg—an infinitely adjustable length loop (32) that is created when the connector (26) is inserted through the sewn fixed length loop (30) of the short (24) strap. When the hunter applies tension to the combined shorter (24) and longer (34) straps, the infinitely adjustable loop (32) of the shorter (24) strap will grip the dead animal's leg with as much force as the hunter decides to apply. The hunter can use just one shorter (24) strap or two, three or four shorter (24) straps but the number of shorter (24) straps must correspond to the number of legs of the dead animal that the hunter desires to restrain/control/stabilize.

The illustrations in FIG. 6a and the alternate 6b shows the third apparatus—the longer (34) strap—looking from the top of the long (34) strap from its “D” Ring (36) to its adjustable end (38). The longer (34) strap can also be made of any number of materials as described in the claims. The opposing jagged ends of the two pieces of the long strap are to indicate that the actual length of the longer (34) strap is not illustrated in relationship to the size of the longer strap's (34) “D” Ring (36) in FIG. 6a. In FIG. 6b the “D” Ring shown in FIG. 6a has been changed to a sewn fixed length loop.

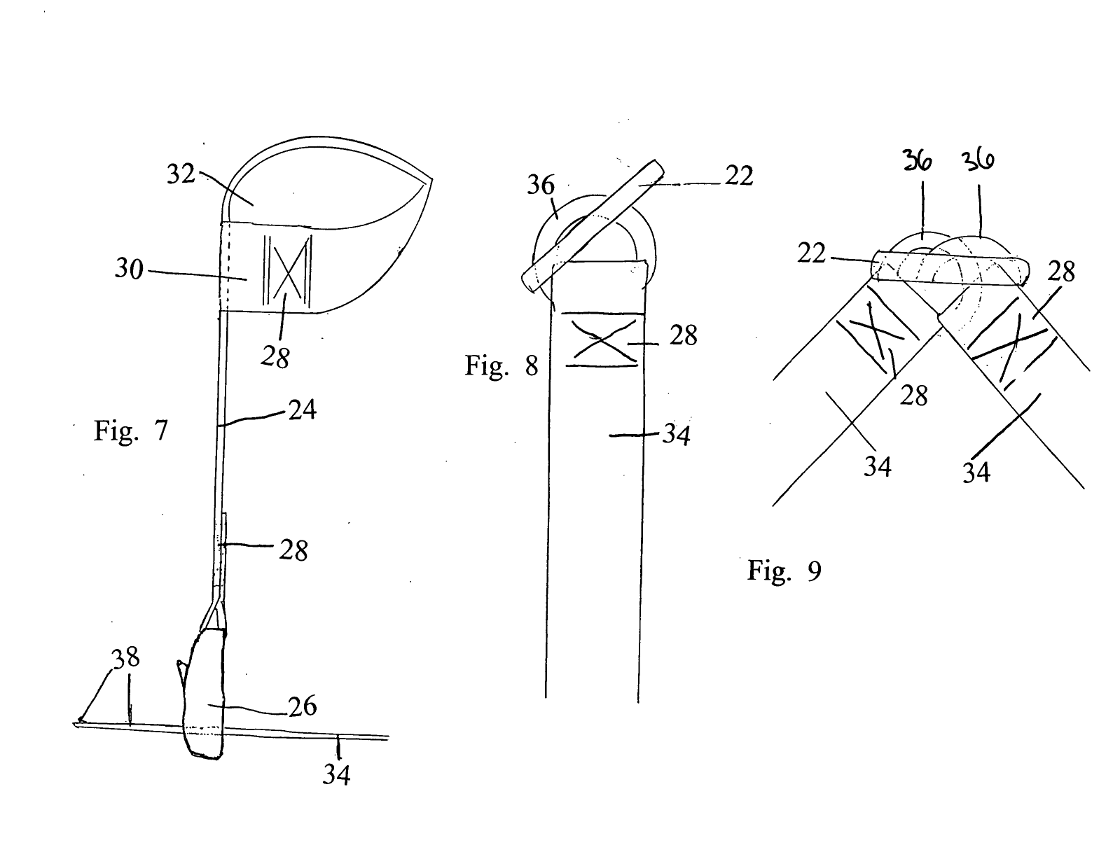

The illustration in FIG. 7 shows the joining of the second and third apparatuses—the shorter strap (24) is connected to the longer (34) strap. In this illustration the combination is made by inserting the adjustable end (38) of the longer (34) strap through a cam buckle—as the connector (26) of the shorter (24) strap. At least 3 to 4 inches of the adjustable end (38) of the longer (34) strap should be pulled through the connector (26). The hunter should use the same number of longer (34) straps as the number of shorter (24) straps that have been attached to the dead animal's legs.

The illustration in FIG. 8 shows the insertion of the stake (20) through one of the longer (34) straps “D” Ring (36) all the way to the stake's (20) custom handle (22) to anchor the animal and the straps to the ground. After inserting the stake (20) through the longer (34) strap's “D” Ring (36) to the stake's (20) custom handle (22), the hunter should center the deer's shoulder over the stake (20) and the “D” Ring (36) from the longer strap (34) which has been already been inserted into the ground up to the stake's handle (22). The other end of the longer (34) strap should then be pulled out to the side of the animal for later use.

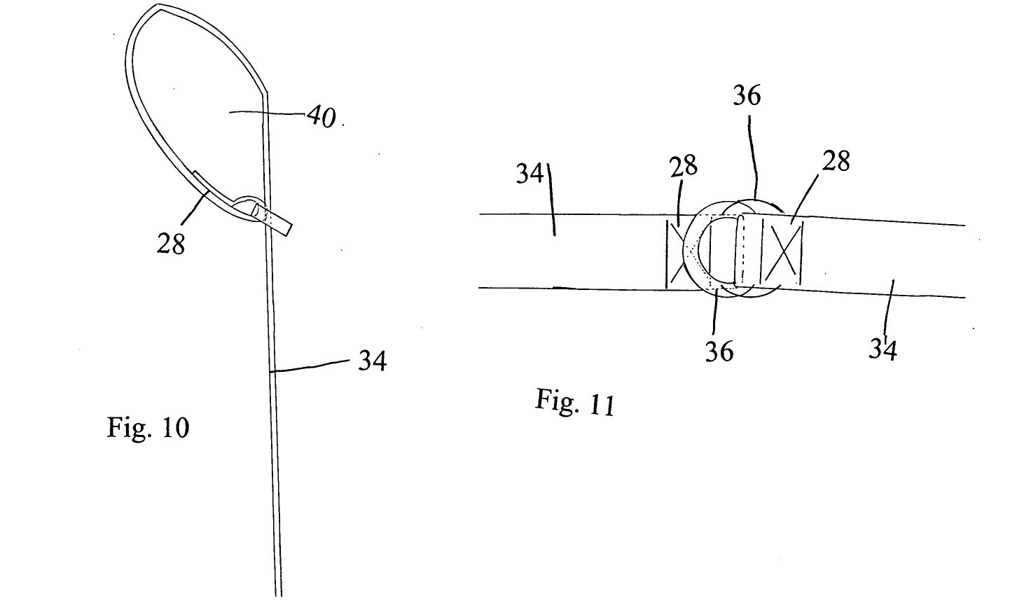

The illustration in FIG. 9 shows the insertion of the stake (20) through two (or more) of the longer (34) strap's “D” Ring (36) to the stake's (20) custom handle (22). The illustration of two longer (34) straps was used to symbolize the possible use of two, three or four longer (34) straps to anchor the animal and the straps to the ground. After inserting the stake (20) through the longer (34) straps, the hunter should center the deer's shoulder over the stake (20) and the longer (34) straps which have been inserted into the ground up to the stake's handle (22) and the longer (34) strap's “D” Ring (36). The other end of the longer (34) straps should then be pulled out to the side of the animal for later use.

### DETAILED DESCRIPTION/OPERATION—SECOND AND THIRD EMBODIMENTS—FIGS. 10 & 11

The illustration in FIG. 10 shows an alternate method to secure the dead animal without using a stake (20) (which is, therefore, not shown). This method can be used if the hunter has (a) lost the stake (20), (b) broken the stake (20) or (c) the ground where the hunter must field dress the dead animal will not allow the hunter to insert the stake (20). In this method the longer (34) strap will have an infinitely adjustable loop (40) which is created by the hunter by putting the adjustable end (38) of the longer (34) strap through the longer (34) strap's “D” Ring (36). This step must be taken before the shorter (24) straps and longer (34) straps have been combined. The hunter should then place the longer (34) strap on the ground. Thereafter, the hunter should place the infinitely adjustable loop (40) of the longer (34) strap on one of the dead animal's left or right front legs and the infinitely adjustable shorter (24) strap's loop (32) over the opposite right or left rear leg. Thereafter, the hunter would combine the shorter (24) strap and the longer (34) strap using the connector (26).

If two longer and shorter (34 and 24) straps are to be used, the hunter should crisscross the two longer (34) straps in create an X pattern and place the dead animal's upper shoulder/lower neck over the X. Then the hunter would have one longer (34) strap's infinitely adjustable loop (40) for each of the front legs, the longer (34) straps would crisscross under the dead animal's lower neck or upper shoulder and the infinitely adjustable loop (32) of the shorter (24) strap would be attached to the opposite rear leg.

FIG. 11 shows one additional method to combine at least two and up to four of the longer (34) straps using the “D” Ring (36). The combined longer (34) straps would be placed under the animal's lower neck/upper shoulder. The manner of connecting the two to three of the longer (34) straps is to insert two to four of the angled, adjustable ends (38) of the longer (34) strap through another longer (34) strap's “D” Ring (36). Then the adjustable ends (38) of two to four of the longer (34) straps should be pulled to the sides of where the hunter will position the dead animal's neck/shoulders. If two sets of straps are being used, the longer (34) strap from the left side of the animal should be placed between the left front leg and the animal's chest and then brought back to attach to the left rear leg's shorter (24) strap whose infinitely adjustable loop (32) has already been placed over the animal's left rear leg. Next the right side's longer (34) strap should be placed between the right front leg and the animal's chest and then brought back to attach to the right rear leg's shorter (24) strap whose infinitely adjustable loop (32) has already been placed over the animal's right rear leg. Once both of the sets of straps are combined, the hunter may create the desired tension by pulling on the adjustable end (38) of each side's longer (34) strap until the hunter is satisfied with the tension.

If the hunter desires to use four sets of straps, each of the longer (34) straps must be connected to each of the leg's shorter (24) straps by pulling the adjustable end (38) of the longer (34) strap through the buckle (26) on the shorter (24) strap after the infinitely adjustable loop (32) of the shorter strap has been placed over each leg of the dead animal. Once all of the sets of straps are attached, the tension desired by the hunter may be easily achieved by pulling on the adjustable end (38) of all four of the longer (34) straps until the hunter is satisfied with the tension.

### CONCLUSION, RAMIFICATIONS AND SCOPE

Accordingly, the reader will see that, according to one embodiment and method of the present invention, we have provided for the use of a stake and one or more sets of straps. We have also provided for an embodiment and method to use only strap(s) to safely, easily and successfully field dress the hunter's dead animal.

While the above description contains many specifics about the embodiments of the apparatus, those specifics should not be construed as limitations on the scope of any of any embodiments but solely as a presently described embodiment of the apparatus. Many other ramifications and variations of the apparatus are possible, even beyond those described and discussed above, within the teachings of the embodiments and the claims. For example, the materials to make the shorter attachment to the animal's leg could vary based upon the hunter's preference from among those items referenced above or even others. In addition, some hunters may prefer to restrain/control/stabilize one, two, three or all four of the animal's legs while other hunters would normally chose to restrain/control/stabilize a different number of legs. Finally, in rocky terrain, it may be impossible to insert any stake into the ground and the hunter must use one of the embodiments that require no stake to be used.

Therefore, the scope of the invention should be determined by the appended claims and all of their legal equivalents. The scope of the invention should not be limited by the few examples of described above or shown in the Drawings but should include all of the appended claims that are reasonably implied by the claims and their legal equivalents.

What is claimed is:

1. An apparatus to field dress a dead animal comprising a stake, a shorter strap and a longer strap.
The stake would have one end that is to be inserted into the ground and a second end that is designed to ease the insertion of the stake (by hand or boot) into the ground. The stake comprises either wood, steel, wire, iron, other metals, plastics or other injectables.
The shorter strap comprises a connector selected from the group consisting of a cam, ratchet, spring or side release buckle; “D” or “O” or other rings; carabiners or any other type of mechanical fasteners on one end of the strap (to attach the shorter strap to the longer strap), material that that strap has been made from and one of the group consisting of a sewn fixed length loop, a “D” or “O” ring or other rings on the other end to facilitate the creation of the infinitely adjustable loop for holding the dead animal's leg(s).
The longer strap has an attachment point for inserting the stake selected from the group consisting of an “O” or “D” ring, a sewn fixed length loop or a grommet on one end of the longer strap, material that that strap has been made from and another end of the material to be used to connect to the shorter strap's connector and then pulled to adjust the tension on the dead animals' legs.
The material that the straps are to be made of shall be selected form the group consisting of flat or tubed (a) nylon, (b) polyester, (c) polypropolene; or (d) rubber; or a chain, wire, rope or twine.

2. The embodiment and method for the hunter to use this apparatus to restrain/control/stabilize just one or as many as all four of the dead animal's legs comprises of the following steps:
a. Determining how many of the dead animal's legs he wants to restrain/control/stabilize,
b. Using one set of the longer and shorter straps for each leg that the hunter decided the hunter wants to restrain/control/stabilize,
c. Connecting the stake and the longer strap together,
d. Inserting the stake into the ground,
e. Pulling the longer straps end to the side (each side) of the stake.
f. Centering the dead animal's shoulders over the stake.
g. Putting the infinitely adjustable shorter strap over each of the dead animal's legs to be controlled.
h. Connecting the longer strap to the shorter strap.
i. Pulling on the end of each longer strap which has been put through the connector in order to secure that leg in the pulled away position.
j. Removing the dead animal's internal organs, which is called “field dressing” a dead animal safely, easily and successfully.

3. The embodiment of claim 1 wherein the longer strap's sewn fixed length loop, “D” or “O” ring is removed, the strap is made even longer and the longer strap is tied around one of the dead animal's front legs and run under the dead animal's body to the other side of the dead animal whereby there would be no need to use the stake used in claim 1. Such an embodiment and method would be useful if the ground around where the dead animal was killed is too rocky or hard to insert the stake. Such an embodiment and method would also be useful if the hunter did not want to make, purchase or carry a stake into the field with the hunter's other hunting equipment.

4. The embodiment of claim 1 wherein the shorter strap's sewn fixed length loop, “D” or “O” ring is removed, the shorter strap is made longer and the shorter strap is also tied around one of the dead animal's rear legs and then connected to the longer strap. In this embodiment and method the dead animal's left/right rear leg's shorter strap would be connected to dead animal's right/left front leg's longer strap. If the hunter desires to restrain/control/stabilize both of the dead animal's rear legs, the hunter would use a second set of these elongated longer and shorter straps to control the other two legs.

5. The embodiment of claim 1 wherein only 1 of the longer straps is used instead of a set of the long and short straps. In this embodiment and method, the alternative longer strap would need to be sufficiently longer than the combined lengths of each of claim 1 set's shorter and longer straps in order to allow a sufficient length to tie each end of the alternative longer strap around the dead animal's leg. In this embodiment and method there would be no need to use the stake.

6. The embodiment of claim 5 wherein there is only one longer strap for each of the dead animal's rear legs that is to be restrained/controlled/stabilized further including an infinitely adjustable loop which is created by running the other end of the long strap through the longer strap's sewn fixed length loop, “D”, “O” or other ring or grommet, The infinitely adjustable loop would then be attached to one of the dead animal's front legs and run under the dead animal and attached to the dead animal by tying or another method of attachment to the dead animal's opposite rear leg.
